(19) United States
(12) Patent Application Publication
(10) Pub. No.: US 2022/0322189 A1
(43) Pub. Date: Oct. 6, 2022

(54) INDOOR AND OUTDOOR SEAMLESS POSITIONING SWITCHING METHOD

(71) Applicant: JastecM CO., LTD., Gyeonggi-do (KR)

(72) Inventor: Yongbeom BAEK, Gyeonggi-do (KR)

(21) Appl. No.: 17/316,835

(22) Filed: May 11, 2021

(30) Foreign Application Priority Data
Mar. 30, 2021 (KR) 10-2021-0041415

(51) Int. Cl. H04W 36/18; H04W 64/00; H04W 36/32; G06K 9/62; H04W 60/04

(52) U.S. Cl. CPC H04W 36/18; H04W 64/006; H04W 36/32; G06K 9/6288; H04W 60/04

(57) ABSTRACT

An indoor and outdoor seamless positioning switching method, wherein at least one of a personal domain exchanging information related to a user with other domains, a IoT domain exchanging information related to a transportation unit with other domains, an infrastructure domain exchanging information related to an infrastructure with other domains, and a positioning domain receiving data from each domain and calculating positioning of the user or the transportation unit is provided, the data being exchanged between the respective domains via a cloud server; and positioning calculation is continuously performed by exchanging the data in the each domain or the cloud server, when the user or the transportation unit moves between indoors or outdoors.

### CROSS REFERENCE TO RELATED APPLICATION

The present application claims priority to Korean Patent Application No. 10-2021-0041415, filed on Mar. 30, 2021, the entire contents of which is incorporated herein for all purposes by this reference.

### BACKGROUND

### 1. Field of the Invention

The present invention relates to an indoor and outdoor seamless positioning switching method that enables seamless positioning calculation between indoor and outdoor areas.

### 2. Description of the Related Art

Along with the development of IoT technology for autonomous vehicles, continuous and seamless positioning calculation between indoor and outdoor areas is becoming increasingly important in various application areas.

### SUMMARY

The present invention has been made keeping in mind the above problems occurring in the related art, and an objective of the present invention is to provide an indoor and outdoor seamless positioning switching method that continuously enables seamless positioning between indoor and outdoor areas.

According to an aspect of the present invention, an indoor and outdoor seamless positioning switching method is proposed, wherein at least one of a personal domain exchanging information related to a user with other domains, a IoT domain exchanging information related to a transportation device with other domains, an infrastructure domain exchanging information related to an infrastructure with other domains, and a positioning domain receiving data from each domain and calculating positioning of the user or the transportation device is provided, the data being exchanged between the respective domains via a cloud server; and positioning calculation is continuously performed by exchanging the data in the each domain or the cloud server, when the user or the transportation device moves between indoors or outdoors.

The positioning fusion actor PT-F may collectively process data from all domains. The information required for positioning calculation may be received from different domains. A common received value of sensor data from sensors in the personal domain PD, the sensor domain SD, and the IoT domain IOTD may be defined. The common received values may be in a common message format and expressed as PVT services in an extended interface for indoor and outdoor seamless positioning calculations in the positioning fusion actor PT-F.

Considering a case where a user (individual) in a building is to board an autonomous vehicle outside at a set time, the location and elevation of the autonomous vehicle and the user can be calculated by continuously tracking the location of the autonomous vehicle and continuously tracking the user's location, thereby obtaining the timing when they meet each other.

The seamless positioning calculation according to the present invention can be associated with various fields, such as transportation device tracking, indoor or indoor navigation, traffic congestion monitoring and control, accident scene finding, emergencies occurrence monitoring, and the like.

### BRIEF DESCRIPTION OF THE DRAWINGS

The above and other objectives, features, and other advantages of the present invention will be more clearly understood from the following detailed description when taken in conjunction with the accompanying drawings, in which:

FIG. 1 is a diagram showing relationships between domains and actors on the basis of a personal domain according to the present invention;

FIGS. 2 and 3 show operation sequences based on a personal domain according to the present invention; and

FIG. 4 is a diagram showing relationships between domains and actors on the basis of an IoT according to the present invention.

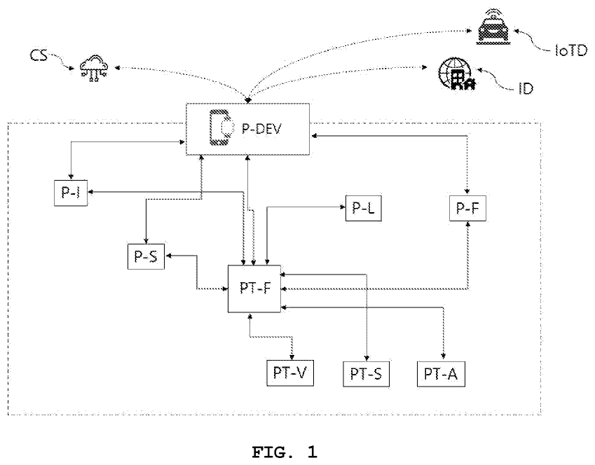

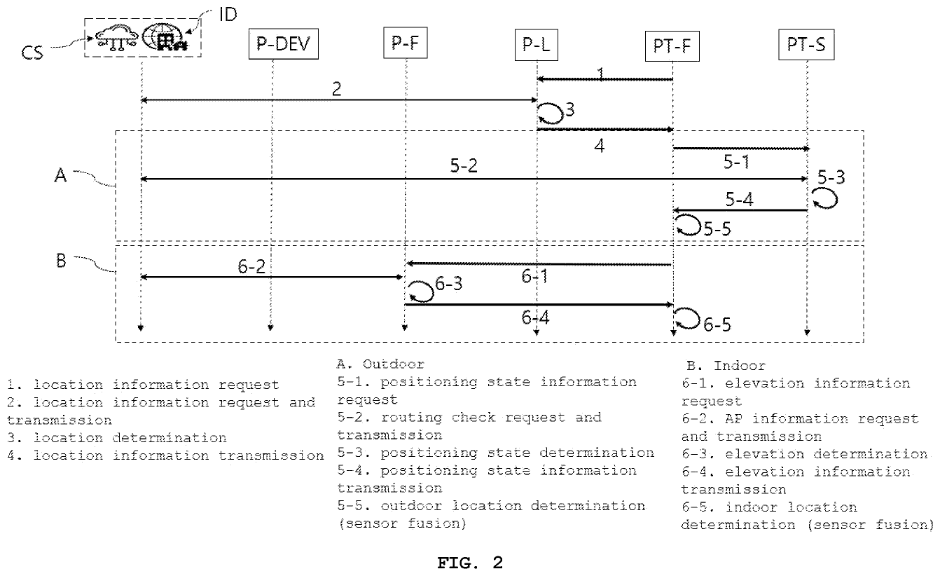

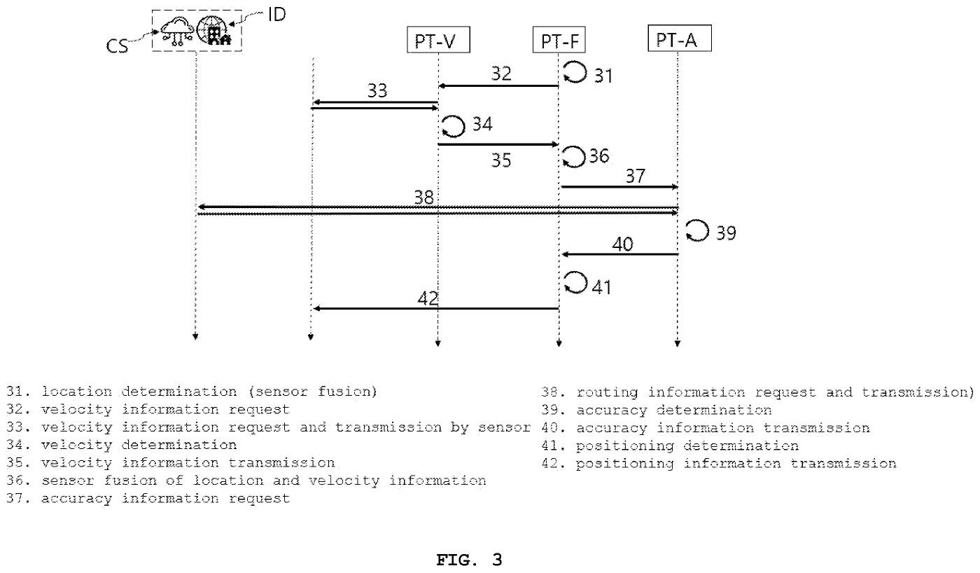

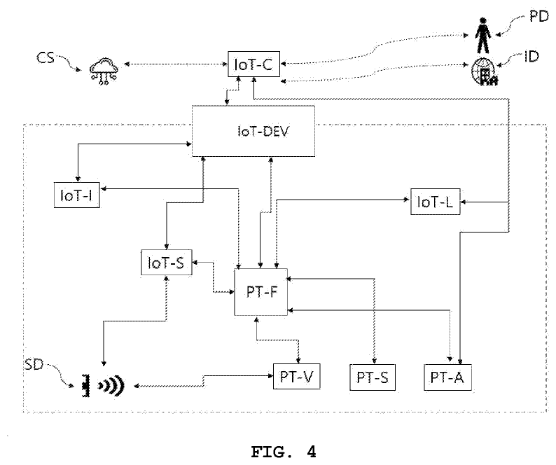

### DETAILED DESCRIPTION

A cloud server CS and a plurality of domains may be provided for the purpose of an indoor/outdoor seamless positioning switching method according to the present invention.

The plurality of domains may include a personal domain PD, an IoT domain IoTD, a sensor domain SD, an infrastructure domain ID, and a positioning domain PTD. Each domain may be classified according to its executing subject and role, and an element belonging to a lower level of each domain may be referred to as an actor.

The personal domain PD may include a personal device actor P-DEV, a personal information actor P-I, a personal state actor P-S, a personal location actor P-L, and a personal elevation actor P-F.

The IoT domain IoTD may include an IoT device actor IoT-DEV, an IoT information actor IoT-I, an IoT communication actor IoT-C, an IoT state actor IoT-S, and an IoT location actor IoT-L.

The positioning domain PTD may include a positioning fusion actor PT-F, a positioning velocity actor PT-V, a positioning state actor PT-S, and a positioning accuracy actor PT-A.

The infrastructure domain ID may include an infrastructure communication actor I-C, an infrastructure location actor I-L, and an infrastructure elevation actor I-F.

A user may receive PVT services from the personal device actor P-DEV. The PVT services may refer to positioning/velocity/timing service. The PVT services may include information about positioning, intersections, accuracy, or the like.

The process in which the personal device actor P-DEV obtains the PVT service will be described on the basis of the personal domain PD.

The personal device actor P-DEV may retrieve registration information from the personal information actor P-I, and then receive personal registration information such as age and presence or absence of a disability. Although the personal device actor P-DEV may make a retrieval request to the personal information actor P-I and then receive the same, the positioning fusion actor PT-F makes a retrieval request for the personal registration information to the personal information actor P-I and then receive the same, which is the case in which the positioning fusion actor PT-F collects information necessary for calculating all positioning and then calculates the resulting positioning data.

Therefore, in the case that a user intends to retrieve his or her registration information and receive a reply, when the personal device actor P-DEV makes a retrieval request to the personal information actor P-I, the registration information may be transmitted from the personal information actor P-I to the personal device actor P-DEV. However, in the case that a user intends to obtain the final positioning by performing PVT service request, when the personal device actor P-DEV makes a retrieval request for PVT information to the positioning fusion actor PT-F, the positioning fusion actor PT-F makes a retrieval request for personal information to the personal information actor P-I, so that the personal information to be used for the positioning calculation may be transmitted from the personal information actor P-I to the positioning fusion actor PT-F.

According to a request from the user, when the personal device actor P-DEV may make a request for information about PVT, intersection, accuracy, etc. to the positioning fusion actor PT-F, the positioning fusion actor PT-F may perform sensor fusion of information data received from various sensors and return the resulting data to the personal device actor P-DEV.

The information data received by the positioning fusion actor PT-F may include information obtained from the personal state actor P-S. In other words, when the personal device actor P-DEV may make a request to detect whether a user is moving or not or whether a user is boarding a vehicle or not, to the personal state actor P-S, the personal state actor P-S may receive data from sensors mounted in the personal device actor P-DEV and then transmit the received sensor data to the positioning fusion actor PT-F.

The information data received by the positioning fusion actor PT-F may include information obtained from the personal location actor P-L. In other words, the positioning fusion actor PT-F may make a request to identify locations such as a city center, provinces, tunnels, etc., to the personal location actor P-L, and the personal location actor P-L may transmit a result via a map in the personal device actor P-DEV or map information in a cloud server to the positioning fusion actor PT-F.

The information data received by the positioning fusion actor PT-F may include information obtained from the personal elevation actor P-F. In other words, the personal device actor P-DEV may make a request for information about the number of floors in a building or elevation to the personal elevation actor P-F and retrieve registration information from the infrastructure communication actor I-C through a network mounted in the personal device actor P-DEV, so that the retrieved information may be transmitted to the positioning fusion actor PT-F.

The information data received by the positioning fusion actor PT-F may include information obtained from the positioning velocity actor PT-V. That is, the positioning fusion actor PT-F may make a request for velocity information to the positioning velocity actor PT-V, and the positioning velocity actor PT-V may transmit a velocity value through a sensor in the personal device actor P-DEV to positioning fusion actor PT-F.

The information data received by the positioning fusion actor PT-F may include information obtained from the positioning state actor PT-S. In other words, the positioning fusion actor PT-F may make a request for information such as crossing, traversing, intersection, overpass, stop, etc. to the positioning state actor PT-S, and the positioning state actor PT-S may transmit, to the positioning fusion actor PT-F, state information corresponding thereto.

The information data received by the positioning fusion actor PT-F may include information obtained from the positioning accuracy actor PT-A. That is, the positioning fusion actor PT-F may make a request for routing accuracy or path accuracy to the positioning accuracy actor PT-A, and the positioning accuracy actor PT-A may transmit accuracy information through the analysis of map data in the cloud server CS or map data in the terminal to the positioning fusion actor PT-F.

Each of the above processes will be described in a sequential order, on the basis of the personal domain PD.

In order for the personal device actor P-DEV or the positioning fusion actor PT-F to make a retrieval request for personal information to the personal information actor P-I, a step of registering the personal information may be needed.

In the step of registering the personal information, when a user intends to enter personal information, the user may make a registration request for the personal information to the personal device actor P-DEV, the personal device actor P-DEV may make a registration request for the personal information to the personal information actor P-I, and the personal information actor P-I may register the entered personal registration information.

When the registered personal information may be transmitted from the personal information actor P-I to the cloud server CS and thus also registered in the cloud server CS, the registration may be notified to the personal device. This allows the user to confirm that his/her personal registration information has been registered.

When the user personal information is registered in the personal information actor P-I or the cloud server CS, an information-requesting entity may make a retrieval request for personal information to the personal information actor P-I or the cloud server CS. When the retrieved personal information is transmitted to the information-requesting entity, the information may be used for positioning calculation. When the positioning fusion actor PT-F needs to respond according to the positioning calculation request, information necessary for positioning calculation may be transmitted to the positioning fusion actor PT-F, and thus the final positioning may be calculated on the basis of such information. Therefore, when the personal device actor P-DEV make a request for positioning calculation to the positioning fusion actor PT-F, and the positioning fusion actor PT-F retrieves personal information from the personal information actor P-I, the personal information registered in the personal information actor P-I is transmitted to the positioning fusion actor PT-F, and the positioning fusion actor PT-F uses the transmitted personal information to calculate resulting positioning and transmits the resulting positioning to the personal device actor P-DEV.

Considering the case of detecting a user's motion state, when the personal device actor P-DEV may make a request for motion detection to the personal state actor P-S, the personal state actor P-S makes a request for sensor data to personal device actor P-DEV. Then, the personal device actor P-DEV that receives the request signal acquires sensor data and then transmits the sensor data to the personal state actor P-S.

The personal state actor P-S may obtain motion state information using the received sensor data, and the personal state actor P-S may transmit the motion state information and the result value to the positioning fusion actor PT-F. When routing or route tracking is required after the motion is detected, the positioning fusion actor PT-F may send a signal to the personal device actor P-DEV in order to start monitoring for the routing.

When detecting the user's boarding of a mobility, a transportation device, and the like by an IoT device actor IoT-DEV, the IoT device actor IoT-DEV makes a request for pairing to the personal device actor P-DEV, and the personal device actor P-DEV transmits a pairing result notifying the detection of the user's boarding to the IoT device actor IoT-DEV, whereby the IoT device actor IoT-DEV may perform pairing with the personal device actor P-DEV.

The personal device actor P-DEV may transmit the pairing information to the personal state actor P-S, the personal state actor P-S detects the user's boarding on the basis of the transmitted pairing information, and the detection result of the user's boarding may be transmitted to the positioning fusion actor PT-F. The positioning fusion actor PT-F may make a request for routing information of the IoT domain IoTD to perform routing of the personal domain PD or the personal device actor P-DEV to the IoT device actor IoT-DEV.

For the purpose of user positioning, when acquiring information on a city center, provinces, tunnels, the number of floors in the building, and elevation, the positioning fusion actor PT-F may make a request for information to determine the current location to the personal location actor P-L.

When the user is located outdoors, it is possible to confirm a user's location using map information of the personal device actor P-DEV or the cloud server CS. When the user is located indoors, it is possible to receive infrastructure access information and access point AP registration information through the infrastructure communication actor I-C.

In the case that a user enters indoors from outdoors, an infrastructure communication unit transmits access point information and GPS information such as GNSS to check a routing path and then determine a final location value, whereby the personal location actor P-L may receive the final location value. The personal location actor P-L may determine whether the user is indoor or outdoor on the basis of the final location value, and the actor may send this information to the positioning fusion actor PT-F.

When the location information received by the positioning fusion actor PT-F indicates outdoors, the positioning fusion actor PT-F may make a request for state information such as crossing, traversing, intersection, overpass, or stop to the positioning state actor PT-S.

The positioning state actor PT-S may make a request for routing information to the cloud server CS or personal device actor P-DEV, the cloud server CS or personal device actor P-DEV transmits the routing information to the positioning state actor PT-S, and the positioning state actor PT-S may determine the positioning state using the received result and transmit the positioning state information to the positioning fusion actor PT-F.

The positioning fusion actor PT-F may determine the outdoor location using the information received from the personal location actor P-L and the positioning state actor PT-S. In this case, the positioning fusion actor PT-F may perform sensor fusion of sensing information from two different domains.

In addition, the positioning state actor PT-S may perform sensor fusion between data of the personal state actor P-S and the routing data of the cloud server CS or the personal device actor P-DEV and transmit a result of the sensor fusion to the positioning fusion actor PT-F.

That is, although the sensor fusion may be performed for the purpose of the final positioning calculation in the positioning fusion actor PT-F, the sensor fusion may also occur in each actor or unit for the resulting positioning calculation. Therefore, since the sensor fusion of information from different domains may occur in the positioning fusion actor PT-F or a specific domain actor or unit before the final positioning is calculated in the positioning fusion actor PT-F, it is preferable that the sensor fusion occurs in the positioning fusion actor PT-F.

When the location information received by the positioning fusion actor PT-F indicates indoors, elevation information such as the number of floors in a building may be requested from the personal elevation actor P-F, and the personal elevation actor P-F may make a request to check the registration information for an access point AP to the cloud server CS or the infrastructure communication actor I-C.

The cloud server CS or the infrastructure communication actor I-C may transmit the access registration information to personal altitude actor P-F, and the personal elevation actor P-F may determine the number of floors or elevation from the received floor number or elevation information.

The personal elevation actor P-F may transmit the determined floor number or elevation information to the positioning fusion actor PT-F, and the positioning fusion actor PT-F may determine the indoor location using data received from the personal location actor P-L and data received from the personal altitude actor P-F. Herein, sensor fusion may occur in actors in two different domains.

The positioning fusion actor PT-F may determine velocity information and determine accuracy information. This determination of velocity information or determination of accuracy may be performed after the determination of the location information.

The positioning fusion actor PT-F may make a request for velocity information to the positioning velocity actor PT-V, and the positioning velocity actor PT-V may make a request for sensed velocity information to the personal device actor P-DEV or the cloud server CS.

The sensed velocity information may be received from the personal device actor P-DEV or the cloud server CS, and the positioning velocity actor PT-V may transmit a velocity value obtained from the received information to the positioning fusion actor PT-F.

The positioning fusion actor PT-F may determine velocity using the information received from the positioning velocity actor PT-V.

The positioning fusion actor PT-F may make a request for accuracy to the positioning accuracy actor PT-A, and the positioning accuracy actor PT-A may make a request for routing information to the cloud server CS or the personal device actor P-DEV.

The routing information may be received from the map information of the cloud server CS or the personal device actor P-DEV. The positioning accuracy actor PT-A may verify the received routing information to determine an accuracy value, and transmit the accuracy value to the positioning fusion actor PT-F.

The positioning fusion actor PT-F may calculate a PVT service value, that is, final positioning data, using the location information, the velocity information, and the accuracy information that are received. This final positioning data may be transmitted to the personal device actor P-DEV. The personal device actor P-DEV may display the received final positioning data through a screen display such as a panel.

Considering the exchange of information between different domains on the basis of the IoT domain IoTD, the IoT device actor IoT-DEV may exchange information with the outside through the IoT communication actor IoT-C. That is, the IoT device actor IoT-DEV may communicate with the cloud server CS, the personal domain PD, or the infrastructure domain ID through the IoT communication actor IoT-C. That is, when the IoT location actor IoT-L, the positioning state actor PT-S, and the like receive necessary information from the outside, they may communicate with the outside through the IoT communication actor IoT-C or the IoT device actor IoT-DEV.

The IoT device actor IoT-DEV and the IoT communication actor IoT-C may be combined in one place or separately present in different places. For example, the autonomous vehicle may be a model in which an IoT device actor IoT-DEV and an IoT communication actor IoT-C are combined.

The IoT device actor IoT-DEV may receive the final positioning data resulting from the PVT service from the positioning fusion actor PT-F. To this end, a variety of information may be transmitted to the positioning fusion actor PT-F, and the positioning fusion actor PT-F may calculate PVT data or final positioning data using the sensing information or the sensor fusion information that are received.

The IoT device actor IoT-DEV may retrieve registration information from the IoT information actor IoT-I, and the IoT information actor IoT-I may transmit information such as a type of vehicle and a type of fuel used in the vehicle to the IoT device actor IoT-DEV. The IoT device actor IoT-DEV may make a request to detect the user's boarding indicating whether the user is driving a vehicle or walking and the user's driving indicating whether the user is driving, stopping, or parking the vehicle, to the IoT status actor IoT-S. The IoT state actor IoT-S may make a retrieval request for sensing data to the sensor domain SD.

In other words, the user's boarding may be determined through pairing from a sensor of the personal device actor P-DEV, and whether the user is driving may be determined from sensor data of the IoT device actor IoT-DEV. The IoT state actor IoT-S may determine the user's boarding, the user's driving, or the like from the received data and transmit the same to the positioning fusion actor PT-F.

The positioning fusion actor PT-F may make a request for the number of floors in a transportation unit or a result relating to tunnel existence to the IoT Location Actor IoT-L, and the IoT location actor IoT-L may transmit a location result such as the number of floors or tunnels through a map of the IoT device actor IoT-DEV or the cloud server to the positioning fusion actor PT-F.

The positioning fusion actor PT-F may make a request for velocity information to the positioning velocity actor PT-V, the positioning velocity actor PT-V may receive velocity data through a sensor mounted in the IoT device actor IoT-DEV, and the positioning velocity actor PT-V may transmit the velocity data to the positioning fusion actor PT-F.

The positioning fusion actor PT-F make a request for information such as crossing, traversing, intersection, parking, stopping, etc. to the positioning state actor PT-S, and the positioning state actor PT-S may transmit corresponding state data. The positioning fusion actor PT-F may make a request for routing accuracy to the positioning accuracy actor PT-A, and the positioning accuracy actor PT-A may transmit the accuracy through the analysis of map data in the cloud server CS or personal device actor P-DEV to the positioning fusion actor PT-F.

Regarding the registration information of the transportation unit, there may be steps of registering and retrieving the registration information of the transportation unit.

In the step of registering the IoT information actor, a user may make a registration request for transportation unit information to the IoT information actor IoT-I, wherein the transportation unit information may be information such as a type of vehicle such as whether it is a general car or an autonomous vehicle, a car model, and an a type of fuel.

The IoT information actor IoT-I may transmit the transportation unit information to the cloud server CS, and the cloud server CS may register the transportation unit information and then transmit a registration result of the transportation unit information to the IoT information actor IoT-I, so that the user may confirm that the information has been registered through the IoT information actor IoT-I.

In a step of retrieving the transportation unit information, when the user makes a retrieval request for registration information to the transportation unit information register unit and then receives a reply, or needs to retrieve the information necessary for the final positioning calculation via the PVT service, the positioning fusion actor PT-F may make a request for registration information to the transportation unit information register unit.

The IoT information actor IoT-I may directly transmit the registration information to the positioning fusion actor PT-F according to the retrieval request, and, if necessary, the IoT information actor IoT-I may request confirmation to the cloud server CS. When the IoT information actor IoT-I requests retrieval to the cloud server, data flow of request and reply may occur sequentially in the positioning fusion actor PT-F, the IoT Information Actor IoT-I, the cloud server CS, and the positioning fusion actor PT-F.

When detecting whether the user is driving, stopping, or parking the transportation unit, the IoT device actor IoT-DEV may make a request to detect the transportation unit state to the IoT state actor IoT-S, the IoT status actor IoT-S may initiate monitoring of sensors mounted on IoT device actor IoT-DEV, and the IoT status actor IoT-S may receive data from the sensor, and the IoT status actor IoT-S may use the data to detect or determine the transportation unit state such as driving, stopping, and parking.

The IoT state actor IoT-S may transmit the transportation unit state value to the positioning fusion actor PT-F, the positioning fusion actor PT-F may make a retrieval request for the transportation unit registration information to the cloud server CS, and the positioning fusion actor PT-F may determine the transportation unit state using the transportation unit registration information received from the cloud server CS and the status values received from the IoT status actor IoT-S.

Considering the process of determining location information such as downtown, provincial, tunnel, number of floors in a building, or elevation on the basis of the IoT domain IoTD, the positioning fusion actor PT-F may make a request for positioning information to determine current location to the IoT Location Actor IoT-L, and the IoT location actor IoT-L may make a request to check location information through map or infrastructure access information to the IoT device actor IoT-DEV.

In addition, the IoT device actor IoT-DEV may request the location information through the map or infrastructure access information to the IoT communication actor IoT-C, and the IoT communication actor IoT-C may request the location information through map or infrastructure access information to the infrastructure domain ID or the cloud server CS. The infrastructure domain ID or the cloud server CS may transmit the location information to the IoT communication actor IoT-C through access registration information or cloud server CS map (which may contain maps of the personal device actor P-DEV), which is sequentially transmitted to the IoT device actor IoT-DEV and may be transmitted to the IoT location actor IoT-L.

When access point information and GNSS information such as GPS are received at the same time, the final location may be determined after checking the routing path. The IoT location actor IoT-L may determine the location of a city center, provinces, etc. and discriminate whether a user is indoor or outdoor by using the received information. This indoor or outdoor discriminating information may be transmitted to the positioning fusion actor PT-F.

When the information received by the positioning fusion actor PT-F indicates outdoors, the positioning fusion actor PT-F may make a request for the vehicle state information such as crossing, traversing, intersecting, overpass, stop, etc. to the positioning state actor PT-S, and the positioning state actor PT-S may make a request for routing data to the cloud server CS or IoT device actor IoT-DEV. When the positioning state actor PT-S make a request for routing data to the cloud server CS and the data is returned, the data may flow in the order of the IoT device actor IoT-DEV, the IoT communication Actor IoT-C, the cloud server CS, the IoT Communication Actor IoT-C, and the IoT Device Actor IoT-DEV.

When the positioning state actor PT-S uses the routing path data from the cloud server CS or the IoT device actor IoT-DEV and the location data from the positioning fusion actor PT-F to determine the positioning state, the positioning state actor PT-S may perform sensor fusion of information of actors in different domains. As a result of the sensor fusion, an outdoor location may be determined, and the determined information may be transmitted to the positioning fusion actor PT-F.

When the information transmitted by the positioning fusion actor PT-F indicates indoors, the positioning fusion actor PT-F may make a request for information about the number of floors in a building or elevation to IoT Location Actor IoT-L, and the IoT location actor IoT-L may make a request to check access point registration information to the cloud server CS.

The cloud server CS may transmit the access point registration information to the IoT location actor IoT-L, the IoT location actor IoT-L may determine the number of floors or elevation using the received information, the IoT location actor IoT-L may transmit the determination information to the positioning fusion actor PT-F, and the positioning fusion actor PT-F may determine the indoor location using the received determination information. The positioning fusion actor PT-F may perform sensor fusion between the location information and elevation information such as the number of floors received from the IoT location actor IoT-L, thereby determining the indoor location.

Considering the process in which the IoT domain IoTD determines PVT service, the indoor location of the transportation unit is determined by the positioning fusion actor PT-F, so that the velocity information of the transportation unit or accuracy may be determined.

The positioning fusion actor PT-F may make a request for velocity information to the positioning velocity actor PT-V, the positioning velocity actor PT-V may request the sensed velocity data to the IoT device actor IoT-DEV, and the IoT device actor IoT-DEV may sense velocity information using a sensor mounted on the vehicle. The sensed velocity data may be transmitted from the IoT device actor IoT-DEV to the positioning velocity actor PT-V. The positioning velocity actor PT-V may calculate a velocity value from the received velocity data, and the positioning fusion actor PT-F receiving the velocity value may perform sensor fusion of the location information and the velocity information.

The positioning fusion actor PT-F may make a request for accuracy to the positioning accuracy actor PT-A.

When the routing information is stored in the IoT device actor IoT-DEV, the positioning accuracy actor PT-A may make a request for routing information to the IoT device actor IoT-DEV, and the routing information may be transmitted from the IoT device actor IoT-DEV to the positioning accuracy actor PT-A.

When the routing information is stored in the cloud server CS, a signal requesting the routing information may be transmitted in the order of the positioning accuracy actor PT-A, the IoT device actor IoT-DEV, the IoT communication actor IoT-C, the cloud server CS, the IoT Communication Actor IoT-C, the IoT Device Actor IoT-DEV, and the positioning accuracy actor PT-A.

In either case above, the positioning accuracy actor PT-A may verify the transmitted routing information to determine an accuracy value and may transmit the determined accuracy value to the positioning fusion actor PT-F.

The positioning fusion actor PT-F may determine the PVT service data, that is, the resulting positioning of the transportation unit, using information received from the IoT location actor IoT-L, the positioning velocity actor PT-V, and the positioning accuracy actor PT-A.

Considering information exchange between actors or units in each domain on the basis of the sensor domain SD, the personal device actor P-DEV may make a request for data of the service sensor actor S-S to the infrastructure communication actor I-C, the infrastructure communication actor I-C may transmit sensor data in response to the request, the personal device actor P-DEV may receive unique AP (access point) information such as MAC address from the infrastructure communication actor I-C, and may make an inquiry request for AP registration location information to the cloud server CS. The cloud server CS may transmit the registration information to the personal device actor P-DEV.

The database of the cloud server CS may include AP registration location information, information by the service sensor actor S-S such as A-GPS or D-GPS, information by a device sensor actor S-DEV such as UWB, WiFi, Bluetooth beacons, RFID, and the like.

The IoT device actor IoT-DEV may make a request for service sensor data to the infrastructure communication actor I-C, and the infrastructure communication actor I-C may transmit the corresponding sensor data to the IoT device actor IoT-DEV. The IoT device actor IoT-DEV may receive unique AP registration information from the IoT communication actor IoT-C and then make a retrieval request for AP registration location information to the cloud server CS, and the cloud server CS may transmit the registration information to the IoT device actor IoT-DEV.

The IoT communication actor IoT-C may make a request for unique AP registration information and triangulation calculation to the cloud server CS, and the cloud server CS may transmit the AP registration information and the triangulation calculation value.

The location information of the moving object may be calibrated by using the registration information of the infrastructure communication actor I-C. The mobile object may refer to a user's terminal or an IoT terminal of a transportation unit, which may be located in the personal device actor P-DEV or the IoT device actor IoT-DEV.

When calibrating the outdoor location of the personal device actor P-DEV, the cloud server CS may transmit changed GNSS data to the personal device actor P-DEV or the IoT device actor IoT-DEV, which may be transmitted to the positioning fusion actor PT-F. Herein, the positioning fusion actor PT-F may calibrate the location of the personal device actor P-DEV using the changed GNSS data.

When calibrating the outdoor location of the IoT device actor IoT-DEV, the cloud server CS may transmit the changed GNSS information to the IoT communication actor IoT-C, which may be transmitted to the IoT device actor IoT-DEV or the personal device actor P-DEV and then to the positioning fusion actor PT-F. The positioning fusion actor PT-F may correct the location of the IoT device actor IoT-DEV using the changed GNSS data.

When calibrating the indoor location of the personal device actor P-DEV, the IoT device actor IoT-DEV or the personal device actor P-DEV may obtain surrounding AP information from the IoT communication actor IoT-C, and the obtained surrounding AP information may be transmitted to the positioning fusion actor PT-F. The positioning fusion actor PT-F may make a request for the surrounding AP registration information to the IoT device actor IoT-DEV or the personal device actor P-DEV, and the IoT device actor IoT-DEV or the personal device actor P-DEV may make a request for the surrounding AP registration information to the cloud server CS. The surrounding AP registration information may be transmitted from the cloud server CS to the positioning fusion actor PT-F through the IoT device actor IoT-DEV or the personal device actor P-DEV. Accordingly, the positioning fusion actor PT-F may calibrate the location of the indoor personal device actor P-DEV using the transmitted surrounding AP registration information.

When calibrating the location of the indoor IoT device actor IoT-DEV compared to calibrating the location of the indoor personal device actor P-DEV, a step in which the data is transmitted/received through the IoT communication actor IoT-C between the IoT device actor IoT-DEV or the personal device actor P-DEV and the cloud server CS may be added.

The location information of the moving object may be used through the service sensor actor S-S.

The IoT device actor IoT-DEV (including the IoT communication actor IoT-C when the IoT device actor IoT-DEV and the IoT communication actor IoT-C are integrated, such as a self-driving car) or the personal device actor P-DEV periodically or intermittently makes a request to initiate or update service information to the cloud server CS or the service sensor actor S-S in the cloud server CS. The cloud server CS or the service sensor actor S-S in the cloud server CS may transmit the service information initiated or updated through downloads, etc. to the IoT device actor IoT-DEV or the personal device actor P-DEV. The IoT device actor IoT-DEV or the personal device actor P-DEV may store or utilize the received information.

The positioning Fusion Actor PT-F may make a request for service sensor information service to determine the current location to the IoT device actor IoT-DEV or the personal device actor P-DEV, receive information stored or updated in the IoT device actor IoT-DEV or the personal device actor P-DEV, and use the information to determine the current location of the personal device actor P-DEV or IoT device actor IoT-DEV.

Considering the relationship between actors or units in each domain on the basis of the infrastructure domain ID, the personal domain PD or the IoT domain IoTD may make a request to register AP-specific information or calculate triangulation to the infrastructure communication actor I-C, and the cloud server CS may return the AP location information and the triangulation calculation value registered to the infrastructure communication actor I-C according to the request. The cloud server CS may include AP registration location information, an infrastructure location actor I-L, and an infrastructure elevation actor I-F.

It is possible to use location information of the moving object through the registration information of the infrastructure communication actor I-C.

When the IoT device actor IoT-DEV and the IoT communication actor IoT-C are integrated, such as in an autonomous vehicle, the IoT communication actor IoT-C or the personal device actor P-DEV may obtain a unique value or unique key of the surrounding AP from the cloud server CS, the IoT device actor IoT-DEV or the personal device actor P-DEV may make a request for surrounding AP registration information to the cloud server CS, and the cloud server CS may transmit the surrounding AP registration information to the IoT device actor IoT-DEV or the personal device actor P-DEV according to the request. The surrounding AP registration information is transmitted from the IoT device actor IoT-DEV or the personal device actor P-DEV to the positioning fusion actor PT-F, so that the location of the moving object may be determined or utilized.

Considering the personal domain PD with respect to data transmission, as the personal device actor P-DEV makes a request for positioning calculation, personal information on gender, age, presence of disability, or a type of disability in the personal information actor P-I may be transmitted to the positioning fusion actor PT-F.

Motion detection information, such as whether there is a motion based on the IMU sensor, the user's travel distance, whether to board the IoT device actor IoT-DEV, or a type of the IoT device actor IoT-DEV may be transmitted from the personal state actor P-S to the positioning fusion actor PT-F.

Indoor location information, information about distinguishing outdoor places such as a city center, provinces, tunnels, and parking lots, information about analyzing the situation of surrounding infrastructure such as crossing, traversing, and intersections, the user's location of the number of floors, or elevation information may be transmitted from the Personal Location Actor P-L or personal elevation actor P-F to the positioning fusion actor PT-F.

Therefore, the positioning fusion actor PT-F may calculate the positioning by using location information from at least one of the personal information actor P-I, the personal state actor P-S, the personal location actor P-L, or the personal elevation actor P-F that correspond to the respective actors in the personal domain PD.

Considering the IoT domain IoTD with respect to data transmission, registration information of transportation unit such as a type of vehicle, car model, a type of fuel, license plate, etc. may be transmitted from the IoT information actor IoT-I to the IoT device actor IoT-DEV according to the positioning calculation request from the IoT device actor IoT-DEV. The IoT device actor IoT-DEV may be associated with the personal device actor P-DEV, and may transmit and receive the data through the IoT communication actor IoT-C.

The motion detection information, including operation state of the vehicle such as driving, stopping, parking, start on/off, travel distance of the transportation unit, whether the user boards the vehicle or not, discrimination of the driver or passenger, or number of occupants, may be transmitted from the IoT state actor IoT-S to the positioning fusion actor PT-F.

The indoor location information, information about discriminating outdoor places such as a city center, provinces, tunnels, and parking lots, information about analyzing surrounding infrastructure situation such as crossing, traversing, and intersections, or location or elevation information of the IoT device actor IoT-DEV that is elevation information such as the number of floors may be transmitted from the positioning location actor PT-L to the positioning fusion actor PT-F.

Therefore, the positioning fusion actor PT-F may calculate positioning by using the transportation unit from at least one of the IoT information actor IoT-I, the IoT state actor IoT-S, or the IoT location actor IoT-L corresponding to each actor in the IoT domain IoTD, or the location information of the IoT device actor IoT-DEV.

What is claimed is:

1. An indoor and outdoor seamless positioning switching method, wherein at least one of a personal domain exchanging information related to a user with other domains, a IoT domain exchanging information related to a transportation unit with other domains, an infrastructure domain exchanging information related to an infrastructure with other domains, and a positioning domain receiving data from each domain and calculating positioning of the user or the transportation unit is provided, the data being exchanged between the respective domains via a cloud server; and
positioning calculation is continuously performed by exchanging the data in the each domain or the cloud server, when the user or the transportation unit moves between indoors or outdoors.

2. The method of claim 1, wherein the respective domains include actors;
when a positioning calculation request is input to a personal device actor included in the personal domain or an IoT device actor included in the IoT domain, a positioning fusion actor included in the positioning domain collects information necessary for the positioning calculation from other domains or actors;
the positioning fusion actor included in the positioning domain collects the information necessary for the positioning calculation in a sensor fusion manner to calculate positioning that is resulting data; and
the information necessary for the positioning calculation includes at least one of registration information of the user or the transportation unit, information on state, location, and elevation, and information on location and elevation of the infrastructure.

3. The method of claim 1, wherein the personal domain is provided with a personal device actor that is an action entity of the personal domain;
the positioning domain is provided with a positioning fusion actor that is an execution entity of the positioning domain and calculates positioning of the user or the transportation unit;
the personal device actor receives PVT services from the positioning fusion actor, the PVT services including information on the positioning;
the personal device actor or the positioning fusion actor retrieves registration information from a personal information actor of the personal domain and then receives the registration information; and
the registration information received by the positioning fusion actor includes information obtained from a personal state actor of the personal domain.

4. The method of claim 1, wherein a personal state actor of the personal domain receives a request to detect a user's motion or a user's boarding of the transportation unit from a personal device actor of the personal domain;
the personal state actor receives data of a sensor mounted on the personal device actor and transmits the data of the sensor to a positioning fusion actor of the positioning domain;
the positioning fusion actor makes a request for location classification to a personal location actor in the personal domain; and
the personal device actor makes a request for information about the number of floors in a building or elevation to the personal elevation actor of the personal domain.

5. The method of claim 1, wherein the infrastructure domain contains an infrastructure communication actor, the infrastructure communication actor being a network access terminal of a router mounted in a major place of the infrastructure,
a positioning fusion actor of the positioning domain makes a request for velocity information of the user to a positioning velocity actor of the positioning domain, the positioning velocity actor transmitting the velocity information of the user to the positioning fusion actor,
the positioning fusion actor makes a request for state information of the user including crossing, traversing, intersection, overpass, and stop to a positioning state actor of the positioning domain, the positioning state actor transmitting state information corresponding to the request to the positioning fusion actor; and
the positioning fusion actor makes a request for routing accuracy or path accuracy to a positioning accuracy actor of the positioning domain, the positioning accuracy actor transmitting accuracy information through analysis of map data in the cloud server or a terminal to the positioning fusion actor.

6. The method of claim 1, wherein a positioning fusion actor of the positioning domain performs sensor fusion of information transmitted by actors of other domains;
when the user is located outdoors, a personal device actor of the personal domain or the cloud server checks the location of the user using map information;
the positioning fusion actor determines the outdoor location of the user using information received from a personal location actor of the personal domain and a positioning state actor of the positioning domain;
when the user is located indoors, infrastructure access information or access point (AP) registration information is received through an infrastructure communication actor of the infrastructure domain;
when the location information received by the positioning fusion actor indicates indoors, elevation information such as the number of floors in the infrastructure or a building is requested to the personal elevation actor of the personal domain, and the cloud server or the infrastructure communication actor transmits access registration information to the the personal elevation actor; and
the positioning fusion actor performs sensor fusion to determine the indoor location using the information received from the personal location actor and information received from a personal elevation actor.

7. The method of claim 1, wherein a positioning fusion actor of the positioning domain performs sensor fusion of information transmitted by actors of other domains;
the positioning fusion actor determines location of the user and then determines velocity of the user or accuracy, the determining of the velocity or the determining of the accuracy being performed after the determining of the location;
the positioning fusion actor makes a request for accuracy information to a positioning accuracy actor of the positioning domain;
the positioning accuracy actor makes a request for routing information to the cloud server or a personal device actor, receives routing path information from map information of the cloud server or the personal device actor, verifies the received routing information to determine an accuracy value, and transmits the accuracy value to the positioning fusion actor; and
the positioning fusion actor calculates resulting positioning from information on the location, velocity, and accuracy that are received.

8. The method of claim 1, wherein the IoT domain includes an IoT device actor, an IoT information actor, an IoT communication actor, an IoT state actor, and an IoT location actor;
the IoT device actor communicates with the IoT information actor through the IoT communication actor and retrieves transportation unit registration information;
the IoT device actor makes a request to detect a user's boarding of the vehicle or a user's driving of the vehicle to the IoT state actor, the user's boarding of the vehicle being determined from sensor data of a personal device actor of the personal domain, and the user's driving of the vehicle is determined from sensor data of the IoT device actor; and
the IoT state actor determines the user's boarding of the vehicle or the user's driving of the vehicle on the basis of the received data and then transmits the same to a positioning fusion actor of the positioning domain.

9. The method of claim 1, wherein when using location information of a moving object that is a personal device actor or an IoT device actor, through registration information of an infrastructure communication actor that is a network access terminal of a router mounted in a major place of the infrastructure,
the mobile object obtains a surrounding AP unique value or a unique key from the cloud server and makes a request for surrounding AP registration information to the cloud server;
the cloud server transmits the surrounding AP registration information to the moving object in response to the request; and
the surrounding AP registration information is transmitted from the moving object to a positioning fusion actor, the positioning fusion actor determining the location of the moving object.
